(19) United States
(12) Patent Application Publication
(10) Pub. No.: US 2026/0328108 A1
(43) Pub. Date: Oct. 22, 2026

(54) DRY GAS SEAL ARRANGEMENT, TURBOMACHINE INCLUDING THE ARRANGEMENT AND METHOD

(71) Applicant: NUOVO PIGNONE TECNOLOGIE -S.R.L., Florence (IT)

(72) Inventors: Guido MASI, Florence (IT); Sergio CIPRIANI, Florence (IT); Emanuele RIZZO, Florence (IT); Francesco CONFORTI, Florence (IT)

(21) Appl. No.: 19/122,078

(22) PCT Filed: Oct. 18, 2023
(86) PCT No.: PCT/EP2023/025439

§ 371 Date: Apr. 17, 2025

(30) Foreign Application Priority Data
Oct. 24, 2022 (IT) 102022000021930

(51) Int. Cl. F01D 11/04

(52) U.S. Cl. CPC F01D 11/04; F05D 2240/55

(57) ABSTRACT

The turbomachine comprises a rotor supported by at least one bearing and including a dry gas seal arrangement inboard of the bearing. The dry gas seal arrangement comprises a primary dry gas seal and a secondary dry gas seal. The dry gas seal arrangement further includes a primary seal gas supply, fluidly coupled to a process gas path, and through which gas processed by the turbomachine is supplied to the primary dry gas seal. A secondary seal gas supply is fluidly coupled to a source of inert seal gas and adapted to buffer the secondary dry gas seal with said inert seal gas. A primary vent is fluidly coupled to the primary dry gas seal and to the secondary dry gas seal and adapted to collect process gas leaking from the primary dry gas seal and inert seal gas leaking from the secondary dry gas seal.

### TECHNICAL FIELD

The present disclosure relates to turbomachines. Embodiments disclosed herein specifically concern improvements to seal arrangements of turbomachines.

### BACKGROUND ART

Turbomachines are machines in which a fluid is either compressed (pumps and compressors) or expanded (expanders and turbines) exchanging power with a rotor supported for rotation in a casing.

Specifically, dynamic compressors are turbomachines which accelerate particles of a compressible fluid, e.g. a gas, by transferring thereto mechanical power by means of rotating blades or impellers forming part of a rotor. The rotor has a shaft which is rotatingly supported in a casing by means of axial and radial bearings. At least one end of the shaft usually projects from the casing for connection to a driver, such as a turbine or an electric motor. Sealing arrangements are provided inboard of the bearings to prevent fluid processed by the compressor (referred to as “process fluid”) from leaking along the shaft towards the bearings and the external environment.

Recently, so-called “dry gas seals” are becoming increasingly popular as sealing systems for centrifugal compressors. Dry gas seals are non-contacting, dry-running mechanical face seals, which include a mating or rotating ring and a primary or stationary ring. In operation, grooves in the rotating ring generate a fluid-dynamic force causing the stationary ring to separate and create a gap between the two rings. These seals are referred to as “dry” as they do not require lubricating oil, which involves several drawbacks. Dry gas seals have reduced maintenance requirements. For centrifugal compressors, such dry gas seals are available in different configurations, e.g., so-called tandem configurations and double opposed configurations, which include two dry gas seals in combination. Tandem and double opposed dry gas seals are primarily used in compressors which process toxic or flammable gases.

Dry gas seals of the current art are efficient in reducing leakages of gas from the turbomachine, and require little maintenance. However, they still have some drawbacks. In particular, sealing gas venting from the dry gas seals usually contains contaminants, which cannot be discharged in the environment as such. For instance, methane or other gaseous hydrocarbons contained in gas vented from the primary vents of dry gas seals must be combusted in a flare. This has a two-fold negative environmental impact, since energy contained in the gas is wasted and the resulting combustion gas is discharged in the atmosphere.

Accordingly, it would be desirable to further reduce emissions from dry gas seals in dynamic compressors and other turbomachines.

### SUMMARY

According to one aspect, disclosed herein is a turbomachine, such as a centrifugal compressor, comprising a casing and a rotor rotatably supported in the casing and comprising at least one impeller. The turbomachine further comprises at least one bearing, rotatably supporting the rotor in the casing, and a dry gas seal arrangement disposed between the rotor and the bearing. In some embodiments the rotor is arranged in-between bearings, and is supported for rotation by two end bearings. Two dry gas seal arrangements are provided in this case, on inboard of each bearing.

The dry gas seal arrangement, or each dry gas seal arrangement has an inboard side facing the rotor and an outboard side facing the bearing. Each dry gas seal arrangement comprises a primary dry gas seal at the inboard side of said dry gas seal arrangement and a primary seal gas supply, fluidly coupled to a process gas path, and through which gas processed by the turbomachine is supplied to the primary dry gas seal. The dry gas seal arrangement further comprises a secondary dry gas seal disposed adjacent to the primary dry gas seal outboard of the primary dry gas seal and a secondary seal gas supply, fluidly coupled to a source of inert seal gas and adapted to buffer the secondary dry gas seal with said inert seal gas. A primary vent is fluidly coupled to the primary dry gas seal and to the secondary dry gas seal and adapted to collect process gas leaking from the primary dry gas seal and inert seal gas leaking from the secondary dry gas seal at a first venting pressure and to return at least the leaking process gas toward the process gas path. A secondary vent, is fluidly coupled to the secondary dry gas seal and outboard thereof and adapted to collect inert seal gas leaking from the secondary dry gas seal.

According to a further aspect, disclosed herein is a method for sealing a turbomachine comprising: a rotor having at least one impeller a casing; a bearing rotatably supporting the rotor in the housing; and a dry gas seal arrangement between the rotor and the bearing; wherein the dry gas seal arrangement comprises: a primary dry gas seal at the inboard side of said dry gas seal arrangement; a secondary dry gas seal disposed adjacent to the primary dry gas seal outboard of the primary dry gas seal. The method comprises the following steps:
processing a process gas through a process gas path; wherein the process gas path comprises the turbomachine;
supplying process gas as a primary sealing dry gas to the primary dry gas seal;
supplying an inert gas as a secondary dry gas to the second dry gas seal and buffering the secondary dry gas seal with the inert gas;
collecting process gas leaking from the primary dry gas seal and inert gas leaking from the secondary dry gas seal in a primary vent and retuning at least the leaking process gas to the process gas path;
collecting inert gas leaking from the secondary dry gas seal in a secondary vent.

Further features and embodiments are outlined below and set forth in the appended claims.

### BRIEF DESCRIPTION OF THE DRAWINGS

Reference is now made briefly to the accompanying drawings, in which:

FIG. 1 is a schematic sectional view of a turbomachine, in particular a centrifugal compressor, according to the present disclosure;

FIG. 2 is a detailed sectional view of a dry gas seal arrangement in one embodiment; and

FIG. 3 is a detailed sectional view of a dry gas seal arrangement in another embodiment.

### DETAILED DESCRIPTION

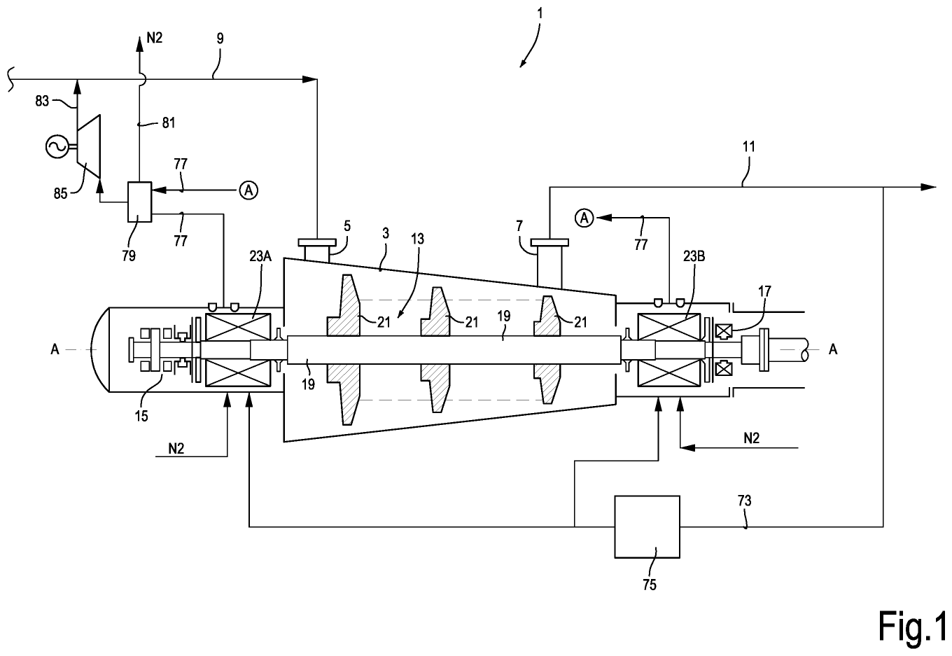

FIG. 1 schematically illustrates a turbomachine 1 provided with dry gas seal arrangements according to the present disclosure. The exemplary turbomachine of FIG. 1 is a centrifugal compressor.

The centrifugal compressor 1 comprises a casing 3 with a process gas inlet 5 at a suction side and a process gas outlet 7 at a delivery side of the compressor 1. The inlet 5 is fluidly coupled to a suction line 9, wherethrough gas at a lower pressure is fed to the compressor. The outlet 7 is fluidly coupled to a delivery line 11, whereto compressed gas at a higher pressure is delivered by the centrifugal compressor 1.

The centrifugal compressor 1 includes a rotor 13, which is rotatably supported in the casing 3 by axial and radial bearings at the ends thereof, schematically shown at 15, 17. In the exemplary embodiment of FIG. 1, the rotor 13 comprises a plurality of impellers 21. The impellers are fitted on a shaft 19 for co-rotation therewith. The shaft 19 is supported at a first end by the bearing or bearing arrangement 15 and extends outside the casing 3 at the opposite end, where the shaft 19 is supported by bearing or bearing arrangement 17. Each bearing, i.e. each bearing arrangement, 15 and 17 includes a radial bearing and at least one of said bearing arrangements 15, 17 includes an axial or thrust bearing.

The impellers can be press-fitted on the shaft. In other embodiments, impellers can be stacked and connected to one another by a tie rod in a so-called stacked-impeller arrangement. In such case, the shaft is partly formed by the inner portion of the stacked impellers. The specific configuration of the impellers and of the shaft is not relevant to the present disclosure. What matters is that the rotor includes impellers and end shaft portions rotatingly engaging in respective bearings.

In the present disclosure and in the attached drawings reference is made to a so-called in-between bearings configuration, wherein the impellers are arranged between two end bearing. In such configuration a sealing arrangement is provided inboard of each bearing. In some embodiments, not shown, one or more impellers can be fitted on a rotary shaft which is supported by a single bearing in a so-called over-hung configuration. In such case, a single sealing arrangement can be provided inboard of the single bearing.

Dry gas seal arrangements 23 and 25 are combined to the bearings 15 and 17, respectively and are located inboard of the bearings 15, 17. Inboard means on the side of the bearing facing inside the casing 3. The two dry gas seal arrangements 23A and 23B can be similar to one another. Only one of them will be described in detail below and will be labeled 23.

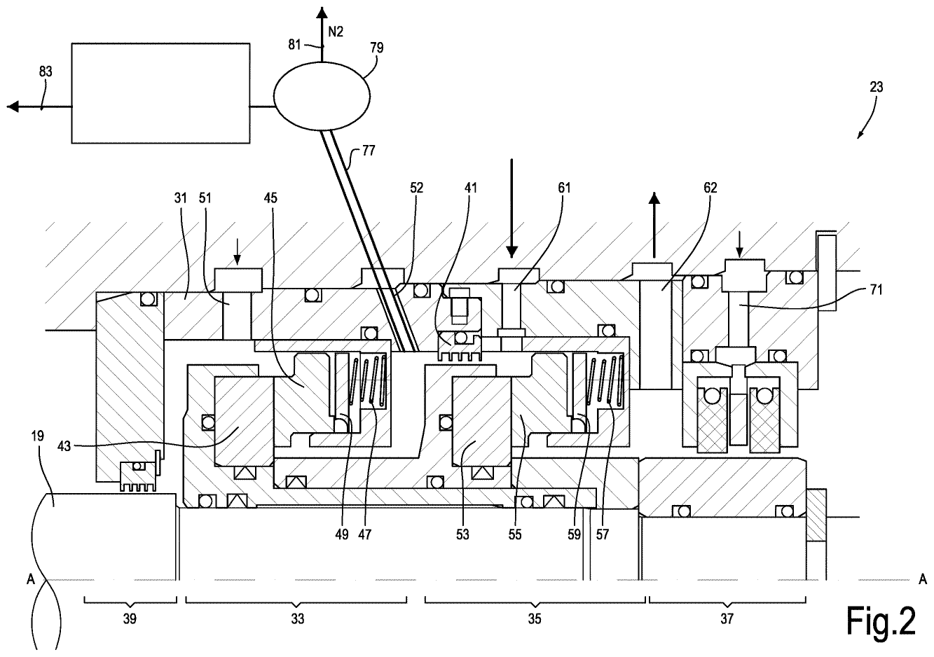

With continuing reference to FIG. 1, a sectional view of a first embodiment of a dry gas seal arrangement 23 is shown in FIG. 2. The sectional view shows only half of the dry gas seal arrangement 23, since the latter is substantially axisymmetric. A-A indicates the rotation axis of the shaft 19 around which the dry gas seal arrangement 23 is arranged. The left side of the dry gas seal arrangement 23 of FIG. 2 is the inboard side, i.e. the side facing the interior of the casing 3, and the right side of the dry gas seal arrangement 23 is the outboard side, i.e. the side facing the relevant bearing or bearing arrangement, whereto the dry gas seal arrangement 23 is combined.

The dry gas seal arrangement comprises a primary dry gas seal 33, also known as inboard gas seal, a secondary dry gas seal 35, also known as outboard gas seal, a separation seal 37, also known as barrier seal, and a process side seal 39, for instance an inner labyrinth seal. The primary dry gas seal 33 is arranged between the process side seal 39 and the secondary dry gas seal, i.e. inboard of the secondary dry gas seal 35. The separation or barrier seal is arranged outboard of the secondary dry gas seal 35. An intermediate labyrinth 41 is arranged between the primary dry gas seal 33 and the secondary dry gas seal 35.

The primary dry gas seal 33 includes a rotating ring 43, which is fitted on the shaft 19 for co-rotation therewith, and a stationary ring 45, which is stationarily housed in the housing 31. Stationary, as understood herein, means that the ring 45 does not rotate with the shaft, but can perform small axial displacements, i.e. displacements in a direction parallel to the rotation axis A-A of the shaft. A resilient member 47 and a thrust ring 49 push the stationary ring 45 against the rotating ring 43 and in contact therewith when the shaft 19 is non-rotating. The rotating ring 43 comprises grooves which, when the shaft 19 and the rotating ring 43 rotate around the rotation axis A-A, generate a flow of dry gas seal which generates a gap between the rotating ring 43 and the stationary ring 45. Primary seal gas is supplied to the primary dry gas seal 33 through ports 51. A major part of the primary seal gas buffers the process side seal 39 and leaks therethrough towards the interior of the compressor casing. A smaller fraction of the primary seal gas leaks between the stationary ring 45 and the rotary ring 43 and is collected in a primary vent 52.

The secondary dry gas seal 35 includes a rotating ring 53, which is fitted on the shaft 19 for co-rotation therewith, and a stationary ring 55, which is stationarily housed in the housing 31. A resilient member 57 and a thrust ring 59 push the stationary ring 55 against the rotating ring 53 and in contact therewith when the shaft 19 is non-rotating. The rotating ring 53 comprises grooves which, when the shaft 19 and the rotating ring 53 rotate around the rotation axis A-A, generate a flow of secondary seal gas which generates a gap between the rotating ring 53 and the stationary ring 55. Secondary seal gas is supplied to the primary dry gas seal 33 through ports 61.

A part of the secondary seal gas buffers the intermediate labyrinth seal 41 and leaks therethrough towards the primary vent 52. The remaining flow of secondary seal gas leaks between the stationary ring 55 and the rotary ring 53 and is collected in a secondary vent 62.

Separation gas supply ports 71 are arranged to provide a flow of separation gas buffering the separation seal 37. The separation gas leaks partly towards the secondary vent 62 and partly towards the bearing outboard of the dry gas seal arrangement 23.

According to embodiments disclosed herein, the primary seal gas supplied to the primary dry gas seal 33 is process gas from the process gas path, which includes the suction line 9, the interior of the compressor 1 and the delivery line 11. The pressure at which the process gas is delivered to the seal gas supply ports 51 is such that the seal gas flows through the process side seal 39 and through the primary dry gas seal 33. The secondary seal gas is usually nitrogen, or another inert gas. The purpose of the secondary seal gas is to prevent process gas from leaking towards the secondary seal 35.

The process gas leaking through the primary dry gas seal 33 and the secondary seal gas leaking through the intermediate labyrinth seal 41 are collected in the primary vent 52 and re-compressed for re-injection in the process gas path.

In some embodiments, the process gas can be natural gas, such as methane. In other embodiments, the process gas can be a refrigerant for a natural gas liquefaction plant, ammonia, hydrogen, or other gas, which should not leak towards the environment.

In FIG. 1 a process gas supply line 73 is schematically indicated to supply process gas to both dry gas seal arrangements 23A, 23B. The process gas used as primary seal gas supply can be pre-treated before delivery to the dry gas seal arrangements 23A, 23B. Pre-treatment can be aimed at removing polluting agents, humidity and other impurities from the process gas. A seal gas pre-treatment unit for that purpose is schematically shown at 75 in FIG. 1.

Primary seal gas and secondary seal gas vented through the primary vent 52 is collected in a venting line 77 from both dry gas seal arrangements 23A, 23B and can be processed in a separator 79 (FIGS. 1 and 2). The separator 79 is adapted to separate process gas, for instance natural gas, from the secondary seal gas, for instance nitrogen. This latter can be discharged in the environment at 81 while the process gas is recycled into the process gas path at 83. A process gas compressor 85 can be provided to boost the pressure of the vented process gas at the correct pressure for re-injection thereof in the process gas path.

The secondary seal gas supplied through ports 61 is an inert gas, i.e. a gas which can be discharged in the environment and/or which can be mixed with the process gas. In embodiments disclosed herein the secondary seal gas is nitrogen (N₂). Inert gases other than nitrogen can be used as secondary seal gas, for instance helium. However, nitrogen is far less expensive and therefore preferred for this application.

Similarly, the separation gas supplied through the separation gas supply ports 71 can be nitrogen or another inert gas that can be discharged in the atmosphere.

Thus, the gas vented through the secondary vent 62 comprises only environ-mental-friendly, inert gas, which can be discharged in the atmosphere.

The above-described dry gas seal arrangement achieves therefore a zero-leak-age system, in that the process gas is fully recovered and recycled, rather than discharged in the atmosphere or flared. Only inert gas, such as nitrogen, is dispersed in the environment, with zero environmental impact.

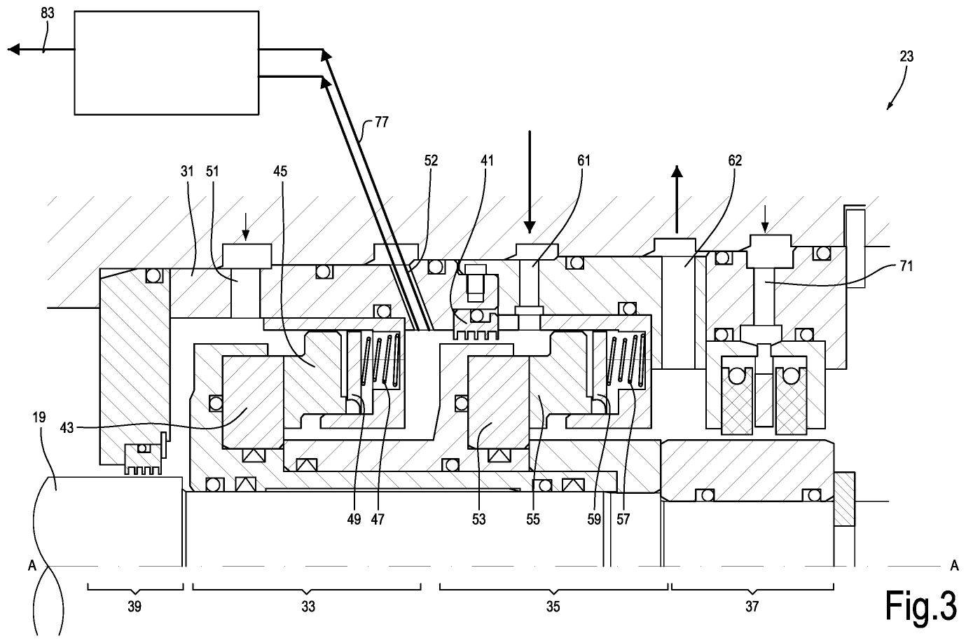

With continuing reference to FIGS. 1 and 2, a further embodiment of a dry gas seal arrangement 23 is shown in FIG. 3. The same reference numbers in FIG. 3 designate the same components, parts or elements shown in FIG. 2 and described above. These elements will not be described again. The main difference between the embodiment of FIG. 2 and the embodiment of FIG. 3 is that the embodiment of FIG. 3 does not include a separator 79. Gas venting from the primary vent consists of process gas and an inert gas (nitrogen, for instance). The mixture can be returned to the process gas path without separation, since the small amount of inert gas venting from the dry gas seal has no impact if added to the main stream of process gas.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A turbomachine comprising:
a casing;
a rotor rotatably supported in the casing and comprising at least one impeller;
at least one bearing rotatably supporting the rotor in the casing; and
a dry gas seal arrangement disposed between the rotor and the bearing, wherein the dry gas seal arrangement has an inboard side facing the rotor and an outboard side facing the bearing;
wherein the dry gas seal arrangement comprises:
a primary dry gas seal at the inboard side of said dry gas seal arrangement;
a primary seal gas supply, fluidly coupled to a process gas path, and through which gas processed by the turbomachine is supplied to the primary dry gas seal;
a secondary dry gas seal disposed adjacent to the primary dry gas seal outboard of the primary dry gas seal;
a secondary seal gas supply, fluidly coupled to a source of inert seal gas and adapted to buffer the secondary dry gas seal with said inert seal gas;
a primary vent, fluidly coupled to the primary dry gas seal and to the secondary dry gas seal and adapted to collect process gas leaking from the primary dry gas seal and inert seal gas leaking from the secondary dry gas seal at a first venting pressure and to return at least the leaking process gas toward the process gas path; and,
a secondary vent, fluidly coupled to the secondary dry gas seal and outboard thereof and adapted to collect inert seal gas leaking from the secondary dry gas seal.

2. The turbomachine of claim 1, further comprising a labyrinth seal between the primary dry gas seal and the secondary dry gas seal, wherein the labyrinth seal is buffered by said inert gas.

3. The turbomachine of claim 1, wherein the inert seal gas is nitrogen.

4. The turbomachine of claim 1, further comprising: a separation seal arranged outboard of the secondary dry gas seal, arranged between the secondary dry gas seal and the bearing; and a separation gas supply port adapted to supply a separation gas to the separation seal, wherein the secondary vent is arranged between the secondary dry gas seal and the separation seal.

5. The turbomachine of claim 1, further comprising a gas separator fluidly coupled to the primary vent and adapted to separate process gas and inert gas from one another, wherein the separator is fluidly coupled to the process gas path for returning the separated process gas leaking through the primary dry gas seal to the process gas path.

6. The turbomachine of claim 1, wherein the primary vent is fluidly coupled to the process gas path, to return a mixture of process gas leaking through the primary dry gas seal and inert gas leaking from the secondary dry gas seal toward the process gas path.

7. The turbomachine of claim 1, further comprising an inner labyrinth seal inboard of the primary dry gas seal.

8. A method for sealing a turbomachine comprising: a rotor having at least one impeller a casing; a bearing rotatably supporting the rotor in the housing; and a dry gas seal arrangement between the rotor and the bearing; wherein the dry gas seal arrangement comprises: a primary dry gas seal at the inboard side of said dry gas seal arrangement; a secondary dry gas seal disposed adjacent to the primary dry gas seal outboard of the primary dry gas seal; the method comprising the following steps:
processing a process gas through a process gas path, ; wherein the process gas path comprises the turbomachine;
supplying process gas as a primary sealing dry gas to the primary dry gas seal;
supplying an inert gas as a secondary dry gas to the second dry gas seal and buffering the secondary dry gas seal with the inert gas;
collecting process gas leaking from the primary dry gas seal and inert gas leaking from the secondary dry gas seal in a primary vent and retuning at least the leaking process gas to the process gas path; and,
collecting inert gas leaking from the secondary dry gas seal in a secondary vent.

9. The method of claim 8, wherein a labyrinth seal is arranged between the primary dry gas seal and the secondary dry gas seal, and wherein inert gas flows from the secondary dry gas seal towards the primary vent through the labyrinth seal.

10. The method of claim 8, wherein a separation seal is arranged between the secondary dry gas seal and the bearing; the method further comprising the step of buffering the separation seal with inert gas.

11. The method of claim 8, further comprising the step of separating inert gas from process gas venting through the primary vent and reintroducing the process gas in the process gas path.
